(19) United States
(12) Patent Application Publication
(10) Pub. No.: US 2003/0204736 A1
(43) Pub. Date: Oct. 30, 2003

(54) Apparatus for authenticated recording and method therefor

(75) Inventors: Charles G. Garrison, Taylor, TX (US); David M. Sorensen, Austin, TX (US)

Correspondence Address: IBM Corporation, Intellectual Property Law Dept., Internal Zip 4054, 11400 Burnet Road, Austin, TX, 78758, US

(73) Assignee: International Business Machines Corporation

(21) Appl. No.: 10/132,406

(22) Filed: Apr. 25, 2002

(51) Int. Cl. H04L 9/00; H04L 9/32

(52) U.S. Cl. 713/193; 713/202; 382/115

(57) ABSTRACT

An apparatus, system and method for certifying photographs, videographs and audio recordings are implemented. A unique private encryption key may be associated with the recording device, which, for video may be a digital camera, or for audio recordings, a digital audio recording device. The digital photographic, videographic or audio data may then be encrypted by the recording device in essentially real-time and stored in encrypted form. The rendering of the digital photograph, videograph or digital audio signal into a perceptible form, may be effected by recovery of the corresponding “public” decryption key from the manufacturer of the recording device, and the stored encrypted data may be decrypted after retrieval from the storage device. The decryption key may, for example, be made available by the manufacturer on a web site.

### TECHNICAL FIELD

The present invention relates in general to systems for digital photography, videography and audio recording and in particular to systems and methods for associating digital photographs, videographs and records with the recording instrument generating the photograph, videograph or audio recording.

### BACKGROUND INFORMATION

Advances in digital electronics led to the development of digital imaging systems that are competitive, in both quality and cost, with conventional silver halide photography. These systems derive their advances and capabilities from embedded-system processing power as well as the reduction in costs and increased availability of non-volative storage mechanisms. The latter may include both “silicon” based memory, such as flash memory, or electromechanical systems, such as miniaturized disk drives. As a consequence, digital imaging systems capable of producing good quality photographic images are becoming widely available. Similarly, digital audio recording devices in combination with these advanced storage media provide a mechanism for high quality audio recording comparable to pressed, read-only recordings.

Additionally, software for the editing of digital photographs, video and audio are readily available. (One such product for editing digital photographs is Adobe Photoshop™, a product of Adobe Systems, Inc., San Jose, Calif. Similarly sound files may be adulterated using audio editing software such as Sound Recorder™, a Windows™ accessory, RipEditBurn™ a product of Blaze Audio, Lopez Island, Wash. or Gold Wave Digital Audio Editor™ a product of Gold Wave, Inc., St. Johns, Newfoundland, Canada.) These technologies provide a relatively inexpensive mechanism by which a user who is so inclined may adulterate photographs, videograph and audio recordings. For example, such adulterated photographs were widely circulated on the Internet following the terrorist attacks on the World Trade Center in New York City on Sep. 11, 2001.

In view of this potential, Watermark technology has been developed that makes use of the lower order bits and the transparency bits in combination or alternatively, the low order bits in the digital image that convey no useful information. A message, referred to as a “watermark” may be put in the lower order bits. If the digital photograph is then altered, the watermark is corrupted. In this way, adulteration of the digital image may be detected. However, the watermark technology may be circumvented by adding a new, albeit different, watermark to the altered photograph. Consequently, there exists a need in the art for apparatus and methods for certifying digital photographs, videographs and similar digital representations of user generated content as authentic.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an apparatus for certifying photographic and videographic data in accordance with the present inventive principles;

FIG. 2.1 illustrates, in flow chart form a methodology for certifying photographic and videographic data in accordance with an embodiment of the present invention;

FIG. 2.2 illustrates, in flow chart form, a methodology for displaying photographic and videographic data in conjunction with the methodology of FIG. 2.1;

FIG. 3 illustrates an apparatus for certifying audio information in accordance with the principles of the present invention;

FIG. 4.1 illustrates, in flow chart form, a methodology for certifying audio data, in accordance with the principals of the present invention;

FIG. 4.2 illustrate, in flow chart form, a methodology for reproducing audio information in conjunction with the methodology of FIG. 4.1; and

FIG. 5 illustrates a data processing system for reproducing certified photographic, videographic and audio information in accordance with an embodiment of present invention.

### SUMMARY OF THE INVENTION

The aforementioned needs are addressed by the present invention. Accordingly there are provided apparatus and systems for certifying digital recordings. These include a data converter for generating a first output file having a predetermined data format in response to an input signal from a transducer. An encryption unit operable for receiving the first output file generates a second, enciphered, output file. The encryption unit enciphers the first output file using a secret key corresponding to the recording apparatus. The second, encrypted output file is stored in a storage unit which may be a removable device.

The foregoing has outlined rather broadly the features and technical advantages of the present invention in order that the detailed description of the invention that follows may be better understood. Additional features and advantages of the invention will be described hereinafter which form the subject of the claims of the invention.

### DETAILED DESCRIPTION

The present invention provides systems and methods for certifying the authenticity of photographic, videographic and audio recordings. A unique “private” encryption-key-“public” decryption pair may be associated with the recording device, which, for video may be a digital camera, or for audio recordings, a digital audio recording device. The digital photographic, videographic or audio data may then be encrypted using the private key by the recording device in essentially real-time and stored in encrypted form. The rendering of the digital photograph, videograph or digital audio signal into a perceptible form, may be effected by recovery of the corresponding public decryption key from the manufacturer of the recording device, and the stored encrypted data may be decrypted after retrieval from the storage device. The decryption key may, for example, be made available by the manufacturer on a web site.

In the following description numerous specific details are set forth to provide a thorough understanding of the present invention. For example, specific encryption algorithms may be described, however it would be recognized by those of ordinary skill in the art that the present invention may be practiced without such specific details and other instances, well-known circuits have been shown in block diagram form in order not to obscure the present invention in unnecessary detail. Refer now to the drawings wherein depicted elements are not necessarily shown to scale and wherein like or similar elements are designated by the same reference numeral through the several views.

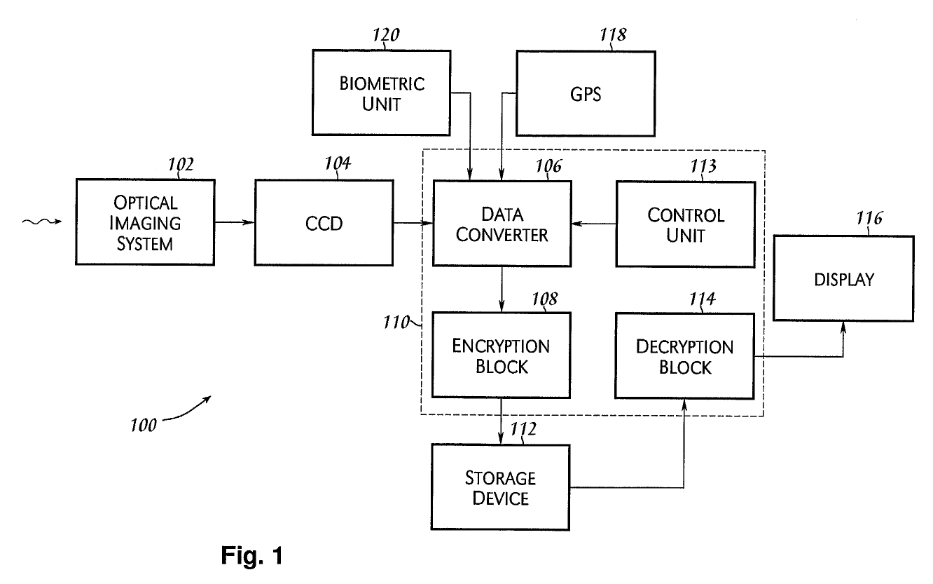

Refer now to FIG. 1, illustrating a photo-recording system 100 in accordance with the principles of the present invention. Photo-recording system 100 may be used to generate digital photographs, or, alternatively, digital videographics. Light from an object to be photographed or videographed is focused by optical imaging system 102 on an optical transducer, such as charge-coupled device (CCD) 104 which converts an optical signal to an electrical signal. Data converter 106 scans the CCD and quantizes the electrical signal output by each pixel of CCD 104. Additionally, data converter 106 converts the resulting digital representation of the optical signal to a graphical file format. Exemplary file formats that may be used in embodiments of the present invention include the Graphics Interchange Format (GIF) and Joint Photographic Experts Group (JPEG) format. Similarly, videographic images may be converted to video data files in accordance with the Moving Picture Experts Group (MPEG) format. The digital image file output by data converter 106 may be encrypted by encryption block 108.

In accordance with the present inventive principles, encryption block 108 may use a so-called asymmetric key encryption algorithm. In an asymmetric key encryption algorithm, the encryption key which is used to encrypt the data to form the ciphertext does not operate to decrypt the ciphertext. (Here “ciphertext” refers to the encrypted digital photograph or video data, which would be generally understood to not be “text” in the sense of human readable symbols such as ASCII characters. Nevertheless, in accordance with conventional terminology in the encryption arts, the unencrypted data will be referred to as “plaintext” and the encrypted data will be referred to as “ciphertext”.) Note that data converter 106 and encryption block 108 may be implemented in an embodiment of the present invention as a portion 110 of a general purpose microprocessor or microcontroller, or, alternatively, as a special purpose processor such as a digital signal processor. In such embodiments the functionality represented by data converter 106 and encryption block 108 may be implemented by software instructions executed by the microprocessor or microcontroller and stored in a memory device (not shown in FIG. 1) photo-recording system 100. Alternatively, data converter 106 and encryption block 108 may be included in an application specific integrated circuit (ASIC). Those of ordinary skill in the art would appreciate that the present inventive principles may be similarly applied in such alternative embodiments.

The encrypted graphics or video file is stored in a non-volatile storage device 112. The storage device may, for example, be a flash memory, a removable floppy, a recordable compact disk, read-only memory (CD-ROM), or a hard drive, such as the IBM Microdrive, a product of IBM Corporation, Armonk, N.Y., in alternative embodiments of the present invention. A particular photo-recording system, such as a digital photocamera or a digital movie camera, may have facilities for incorporating a multiplicity of types of removable storage media.

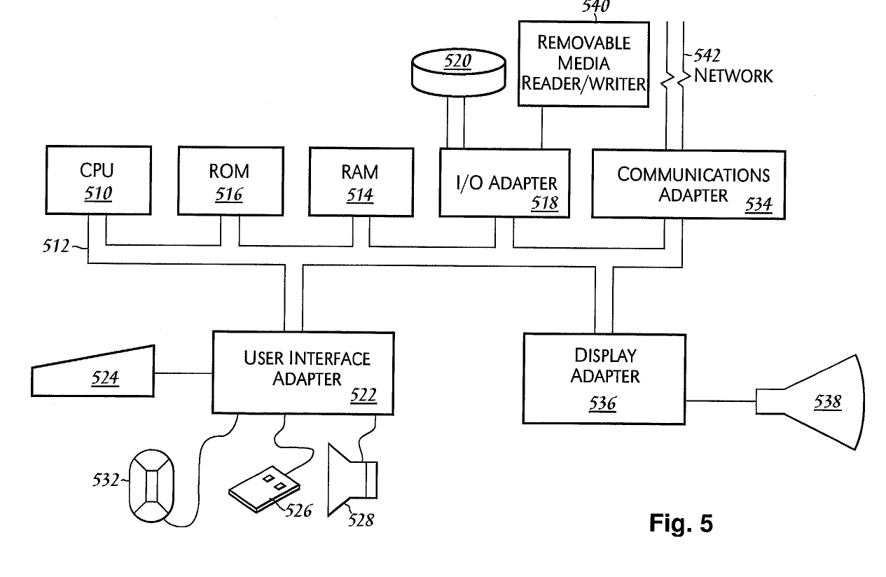

The storage medium may be removed from the recording device and transferred to a data processing system for display, or reproduction in a user perceivable medium as further described hereinbelow in conjunction with FIG. 5. As the data is stored in encrypted form, and the decryption of the data for ultimate rendering on a display device or other user perceivable output may only be performed using a decryption key uniquely associated with the recording device, the user is assured that the particular recording device corresponding to the decryption key is the source of the photograph or videograph.

Stored encrypted data may be selectively reviewed by the user of the recording device via decryption block 114 and display 116. Note that the decryption of the stored data for display is ephemeral, and the data is not otherwise available in plaintext. This notwithstanding, however, the recipient of the encrypted copy that decrypts with the “public” key available from the manufacturer of the recording device or other trusted source, may be assured of the authenticity of the digital photograph or videograph. In this way, the user, or another recipient of the encrypted photograph or videograph may rely on the digital photograph or videograph as representing an unaltered depiction of the subject matter contained therein.

Additionally, a timestamp or other attribute associated with the photographic or videographic recording may be added to the plaintext digital photograph or videograph file. Thus, for example, a timestamp derived from a global positioning system (GPS) receiver 118, which provides a reliable date and time that the image was recorded may be incorporated in the plaintext file. In this way, the user of the digital photograph or videograph having the encrypted file may rely on the accuracy of the embedded timestamp. Note that other attributes that may be associated with the recording may include the location at which the photograph or videograph was taken and parameters related to the recording device itself such as lens aperture, focal length or “zoom” setting, dark frame etc. Control unit 113 which may perform control functions for the recording device may be used to provide recording device data to be incorporated in the plaintext file. Note that, in an alternative embodiment of the present invention, a GPS receiver or other circuitry for incorporating a timestamp or other attribute may be omitted from apparatus 100.

Similarly, the user of the digital recording device may be associated with a particular digital photograph or videograph by embedding a biometric signature into the plaintext file via a biometric input device 120. Biometric input device 120 may, for example, capture a fingerprint of the user as an exemplary biometric signature. Other biometric signatures, such as an iris or retina scan, may be used in alternative embodiments of the present invention. In this way, a particular videographer or photographer may be associated with the digital videograph or photograph, respectively, which association may not be repudiated. Note that, in an alternative embodiment of apparatus 100, biometric input 120 and associated circuitry for inserting a biometric signature may be omitted.

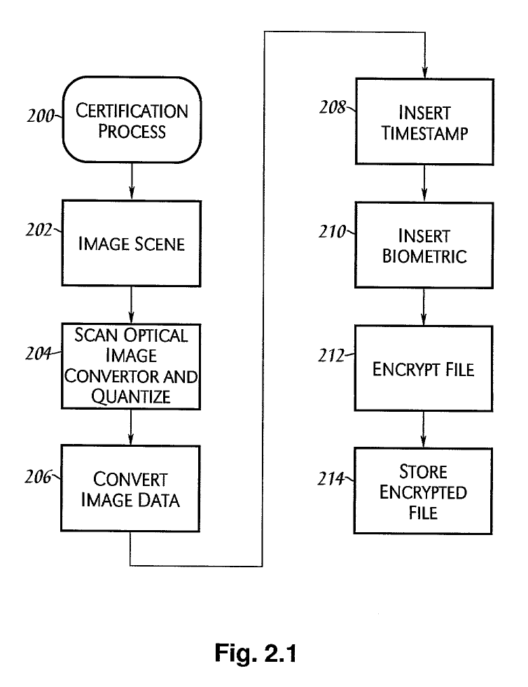

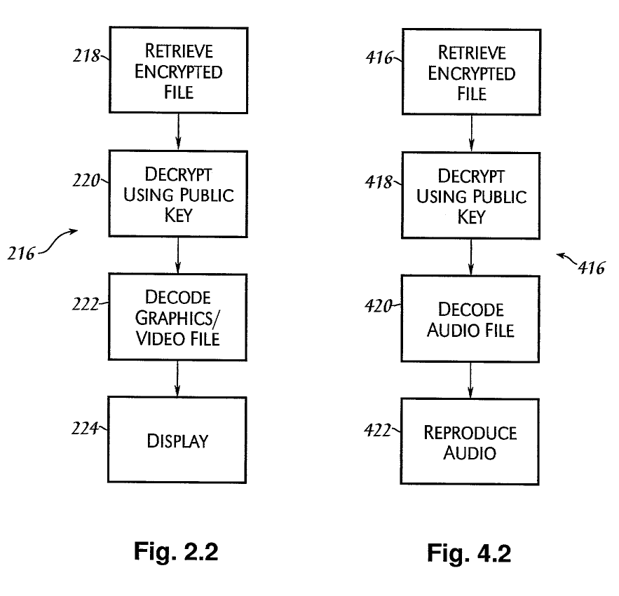

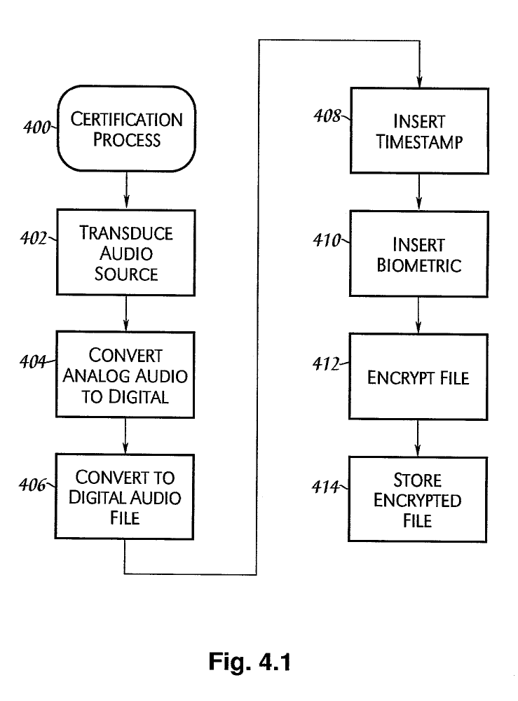

Refer now to FIGS. 2.1 and 2.2 illustrating in flowchart form methodologies in accordance with the present inventive principles. The flowcharts provided herein (and in FIGS. 4.1 and 4.2 below) are not necessarily indicative of the serialization of operations being performed in an embodiment of the present invention. Steps disclosed within these flowcharts may be performed in parallel. The flowcharts are meant to designate those considerations must be performed to execute the certification of photo images and audio recordings, and display/play back selected images/recordings. It is further noted that the order presented is illustrative and does not necessarily imply that the steps must be performed in the order shown.

FIG. 2.1 illustrates methodology 200 for certifying a digital photograph or videograph which may be used in an embodiment of the present invention. The scene being photographed or videographed is imaged in step 202, and in step 204, the optical transducer, such as the CCD (FIG. 1) is scanned. In step 206, the scanned, quantized optical image data is converted to a graphics, or, alternatively, a video, file format, such as a JPEG or GIF, or an MPEG file, respectively.

An attribute associated with the recording, such as a timestamp, and a biometric signature may be inserted in, steps 208 and 210, respectively. Note that in an embodiment of the present invention, the insertion of an attribute and the insertion of a biometric signature may be user selectable. Thus, in such an embodiment, if the user has disabled insertion of an attribute or disabled the insertion of a biometric signature, steps 208 or 210, or both may be bypassed. Alternatively, a photo-imaging system embodiment may be configured to always insert attributes or biometric signatures, or both.

In step 212, graphics or video file is encrypted. The file may be encrypted using an asymmetric encryption scheme. One such encryption scheme which may be used in an embodiment of the present invention is RSA. (The RSA scheme is described in U.S. Pat. No. 4,405,829 of Rivest, Shamir and Adelman.) It would be appreciated by those of ordinary skill in the art that other asymmetric key encryption schemes may be used in alternative embodiments of the present invention, and such embodiments would fall within the spirit and scope of the present invention.

In step 214, the encrypted file is stored. As previously described in conjunction with FIG. 1, storage may be effected in a multiplicity of non-volatile storage media, including flash memory devices, magnetic storage media, or recordable CD media.

The user may also review stored encrypted photographs or videographs. Methodology 216, FIG. 2.2, may be used to display selected photographs or videographs. In step 218, the file containing the selected photo image is retrieved from the storage medium, and in step 220, the file is decrypted using the public key corresponding to the particular photo imaging system. Note that the public key may be stored in the device, but that it need not be stored in a secure fashion. The graphic/videographic file is decoded, step 222 and displayed, which may be by conventional techniques, in step 224.

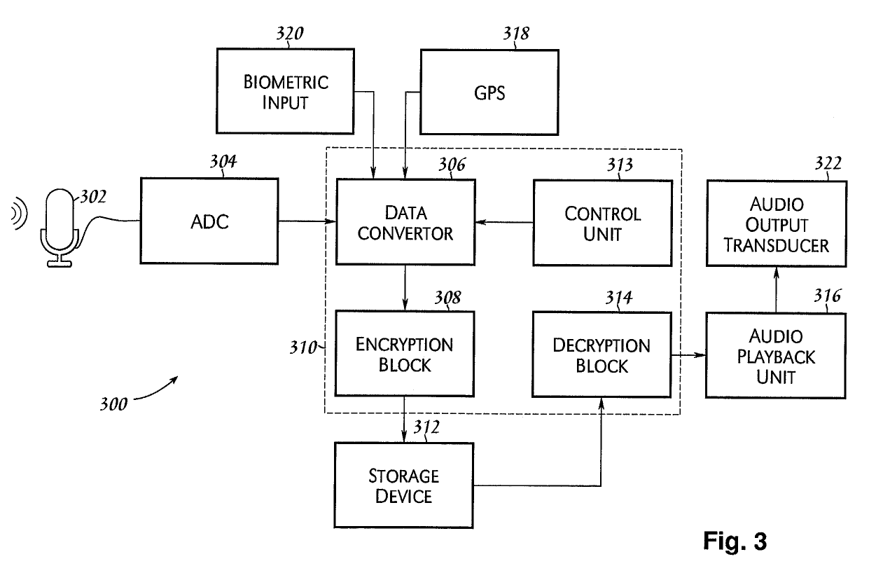

In similar fashion, audio recordings generated in a digital format may be similarly certified. Referring now to FIG. 3, there is illustrated therein an audio recording apparatus 300 in accordance with the present inventive principles. Audio transducer 302 (schematically illustrated as a microphone) converts an audio source to an electrical signal which is provided to analog-to-digital converter (ADC) 304. A digital representation of the audio source is generated by ADC 304, and data converter 306 generates a digital audio file therefrom. The digital audio file may be in a standard format such as an Audio Interchange File (AIFF), an Audio (AU) file, a Waveform Audio (WAV) file or an MPEG-I Audio Layer III (MP3) file. The aforementioned audio file formats are exemplary, and it would be appreciated by those of ordinary skill in the art that other audio file formats may be used in alternative embodiments of the present invention, and that the present inventive principles may be applied in conjunction with such other digital audio file formats.

Encryption block 308 encrypts the digital audio file, which may be encrypted in accordance with an asymmetric encryption scheme as previously described hereinabove in conjunction with FIGS. 2 and 3. Data converter 306 and encryption block 308 may be included in portion 310 of a general purpose microprocessor or microcontroller or alternatively, in a special purpose processor such as a digital signal processor (DSP). In such an embodiment, the data conversion operations and encryption operations may be performed by the processor or controller in response to software instructions, as would be recognized by those of ordinary skill in the art. Alternatively, data convertor 306 and encryption block 308 may be implemented in an ASIC. Artisan of ordinary skill would understand that the present inventive principles may be similarly applied in such alternative embodiments.

The encrypted digital audio file may be provided to a non-volatile storage device 312. Non-volatile storage device 312 may be a removable device in similar fashion to the storage device 112, FIG. 1. Additionally, storage device 312 may output the audio file ciphertext to decryption block 314 to recover the plaintext digital audio file for audio playback. A user may selectively playback stored audio files maintained in storage device 312. Audio playback unit 316 converts the digital audio file to an analog audio signal (decodes the digital audio file format and converts the digital values to an analog signal). The analog audio signal is provided to audio output transducer 322 to generate a user perceivable sound.

Additionally, a reliable timestamp or attribute associated with the recording may be incorporated in the digital audio file in similar fashion to the attributes discussed hereinabove in conjunction with FIGS. 1 and 2. Such an attribute may be derived from a reliable source such as a timestamp derived from a GPS receiver 318. As previously described, attributes may include, in addition to a date and time of recording, the location at which the recording was made and parameters of the recording system. Such attributes may be used by law enforcement, for example, to certify a phone tap. Control unit 313 which may perform control functions for the recording device may be used to provide recording device data to be incorporated in the attribute. GPS receiver 318 and other circuitry for incorporating a timestamp or other attribute may be omitted in an alternative embodiment of apparatus 300. Likewise, a biometric, such as a fingerprint, associated with a user of audio recording device 300 may be captured via biometric input 320 and incorporated in the digital audio file via data converter 306. Note that biometric input 320 and circuitry for incorporating a biometric signature may be omitted in an alternative embodiment of apparatus 300.

FIG. 4.1 illustrates process 400 for certifying audio recordings. The sound being recorded is converted to an analog electrical signal (transduce) in step 402, and in step 404 the analog-audio signal is digitized. In step 406, the digitized signal is converted to a digital audio file format, such as an AU, WAV, AIFF or MP3 file.

A attribute associated with the recording, such as a timestamp and a biometric may be inserted in, steps 408 and 410, respectively. Note that in an embodiment of the present invention, the insertion of an attribute and the insertion of a biometric may be user selectable. Thus, in such an embodiment, if the user has disabled insertion of an attribute or disabled the insertion of a biometric, steps 408 or 410, or both may be bypassed. Alternatively, a recording system embodiment may be configured to always insert an attributes, biometric signatures, or both.

In step 412, graphics or video file is encrypted. The file may be encrypted using an asymmetric encryption scheme. As previously discussed the RSA scheme may be used in an embodiment of the present invention. However, it would be appreciated by those of ordinary skill in the art that other asymmetric key encryption schemes may be used in alternative embodiments of the present invention, and such embodiments would fall within the spirit and scope of the present invention.

In step 414, the encrypted file is stored. As previously described in conjunction with FIG. 1, storage may be effected in a multiplicity of non-volatile storage media, including flash memory devices, magnetic storage media, or recordable CD media.

The user may also review stored audio recordings. Methodology 416, FIG. 4.2, may be used to play back stored recordings. In step 418, the file containing the selected recording is retrieved from the storage medium, and in step 420, the file is decrypted using the public key corresponding to the particular recording system. Note that the public key may be stored in the device, but that it need not be stored in a secure fashion. The digital audio file is decoded, step 422 and played back, which may be by conventional techniques for digital-to-analog conversion, in step 424.

Referring now to FIG. 5, an example is shown of a data processing system 500 which may be used in conjunction with recording devices 200 (FIG. 2) and 300 (FIG. 3). System 500, may for example, be used to retrieve a public key corresponding to the recording device and decrypt and display the graphics/video file or, alternatively, reproduce the audio recording. The system has a central processing unit (CPU) 510, which is coupled to various other components by system bus 512. Read only memory (“ROM”) 516 is coupled to the system bus 512 and includes a basic input/output system (“BIOS”) that controls certain basic functions of the data processing system 500. Random access memory (“RAM”) 514, I/O adapter 518, and communications adapter 534 are also coupled to the system bus 512. I/O adapter518 may be a small computer system interface (“SCSI”) adapter, or alternatively a FireWire™ (IEEE-1394), or Universal Serial Bus (USB) interface that communicates with a disk storage device 520, and a removable device reader/writer 540. Communications adapter 534 interconnects bus 512 with an outside network enabling the data processing system to communicate with other such systems. Input/Output devices are also connected to system bus 512 via user interface adapter 522 and display adapter 536. Keyboard 554, track ball 532, mouse 526 and speaker 528 and microphone 520 and are all interconnected to bus 512 via user interface adapter 522. Display monitor 538 is connected to system bus 512 by display adapter 536. In this manner, a user is capable of inputting to the system throughout the keyboard 554, trackball 535 or mouse 556 and receiving output from the system via speaker 558, display 538.

Preferred implementations of the invention include implementations as a computer system programmed to execute the method or methods described herein, and as a computer program product. According to the computer system implementation, sets of instructions for executing the method or methods are resident in the random access memory 514 of one or more computer systems configured generally as described above. These sets of instructions in conjunction with the system components which execute them, may access, via network 542, which may connect to the Internet for example, a database of public keys corresponding to the recording device. The removable media containing the ciphertext representation of a graphics or audio file, such as a flash memory card, removable hard disk, etc., may be inserted in removable device reader/writer 540. The ciphertext representation may be read and deciphered using the public key. The graphics or audio file may be decoded and displayed or reproduced as appropriate. Additionally any timestamp or biometric may be recovered and displayed. Until required by the computer system, the set of instructions may be stored as a computer program product in another computer memory, for example, in disk drive 520 (which may include a removable memory such as an optical disk or floppy disk for eventual use in the disk drive 520). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. An apparatus for certifying digital recordings comprising:
a data converter for generating a first output file having a predetermined data format in response to an input signal from a transducer;
an encryption unit operable for receiving the first output file and generating a second, enciphered, output file, wherein the encryption unit enciphers the first output file using a secret key corresponding to a recording apparatus; and
a storage device for storing the second output file.

2. The apparatus of claim 1 further comprising a device for generating an attribute associated with a digital recording, the attribute being added to the first output file.

3. The apparatus of claim 2 further comprising a device for generating a biometric signature, the biometric signature being added to the first output file.

4. The apparatus of claim 2 wherein the attribute associated with the digital recording includes one or more of a date, time, location, and a parameter associated with the recording apparatus.

5. The apparatus of claim 4 wherein the device for generating the attribute comprises a global positioning system (GPS) receiver.

6. The apparatus of claim 1 further comprising a lens for imaging a scene to be recorded on the transducer.

7. The apparatus of claim 1 wherein the predetermined data format comprises a digital graphics file format.

8. The apparatus of claim 1 wherein the predetermined data format comprises a digital audio file format.

9. The apparatus of claim 1 wherein the storage device comprises a removable storage medium.

10. The apparatus of claim 1 wherein the transducer comprises a charge-coupled device (CCD), and wherein the data converter is operable for scanning pixels of the charge coupled device.

11. The apparatus of claim 1 further comprising an analog-to-digital converter (ADC) for providing a digital signal to the data converter, and wherein the input transducer comprises an audio transducer coupled to an input of the ADC.

12. A method for certifying digital recordings comprising:
generating a first output file having a preselected file format in response to a signal from a transducer;
encrypting the first output file to form a second, enciphered, output file, wherein the encryption is generated using a private key corresponding to a recording device for performing the generating and encrypting steps; and
storing the second output file.

13. The method of claim 12 further comprising inserting an attribute associated with digital recording in the first output file, wherein the attribute is selected from the group consisting of a date and time, a location indicator corresponding to a place where a recording is made, and a recording device parameter.

14. The method of claim 12 further comprising inserting a biometric signature in the first output file.

15. The method of claim 13 wherein the attribute is derived from a Global Positioning System (GPS).

16. The method of claim 12 wherein the preselected file format is selected from one or more of an Audio Interchange File (AIFF), an AU file, a Waveform Audio file (WAV), an MPEG-I Audio Layer III file (MP3), a Graphics Interchange Format file format (GIF), a Joint Photographic Experts Group file format (JPEG) and a Moving Picture Experts Group file format (MPEG).

17. The method of claim 12 wherein the encrypting step uses the RSA encryption algorithm.

18. A data processing system for reproducing a recording comprising:
a central processing unit (CPU); and
a memory for storing a program of instructions and data for the CPU; and
a storage interface unit adapted for receiving a stored, enciphered recording file, wherein the program of instructions includes instructions for retrieving a public key corresponding to a recording device generating the recording file and instructions for decrypting the enciphered recording file using the public key.

19. The data processing system of claim 19 wherein the program of instructions includes instructions for recovering a biometric signature from a decrypted recording file.

20. The data processing system of claim 18 wherein the storage interface unit comprises a storage interface unit for reading a removable storage medium.
